(19) United States
(12) Patent Application Publication
(10) Pub. No.: US 2009/0042030 A1
(43) Pub. Date: Feb. 12, 2009

(54) MINERAL WOOL, INSULATING PRODUCT AND PRODUCTION METHOD

(75) Inventors: Jerome Douce, Paris (FR); Philippe Espiard, Gouvieux (FR); Valerie Dupouy, La Chapelle En Serval (FR)

Correspondence Address: OBLON, SPIVAK, MCCLELLAND MAIER & NEUSTADT, P.C., 1940 DUKE STREET, ALEXANDRIA, VA, 22314, US

(73) Assignee: SAINT-GOBAIN ISOVER, Courbevoie (FR)

(21) Appl. No.: 11/910,333

(22) PCT Filed: Mar. 31, 2006
(86) PCT No.: PCT/FR2006/050283

§ 371 Date: Apr. 2, 2008

(30) Foreign Application Priority Data
Apr. 1, 2005 (FR) 0550862

(51) Int. Cl. E04B 1/74; B05D 7/00; B32B 17/02

(52) U.S. Cl. 428/392; 501/36; 252/62; 427/215

(57) ABSTRACT

The invention relates to a mineral wool which can dissolve in a physiological medium, comprising fibres having a chemical composition that contains the following constituents in the limits defined hereafter and expressed in percentage by weight, namely: 35 to 75 SiO₂; 0 to 12 Al₂O₃; 0 to 30 CaO; 0 to 20 MgO; 0 to 20 Na₂O; 0 to 10 K₂O; 0 to 10 B₂O₃; 0 to 5 Fe₂O₃; and 0 to 3 P₂O₅, said mineral wool also comprising at least one phosphorus compound. The invention is characterised in that a phosphorus compound is a molecule in which the phosphorus atom(s) are bound to at least one carbon atom either directly or by means of an oxygen atom.

The present invention relates to the field of artificial mineral wools. It relates more particularly to glass wools intended to be incorporated into thermal and/or acoustic insulation materials.

Mineral wools are capable, when certain geometric criteria in terms of diameter and/or length are observed, of being introduced by inhalation into the body and especially into the lungs, sometimes all the way to the pulmonary alveoli. To prevent any pathogenic risk linked to a possible accumulation of fibers in the body, it has become necessary to make sure that the fibers have a low “biopersistence”, that is to say that they can be easily and rapidly eliminated from the body. The chemical composition of the fibers is a major parameter influencing this ability to be rapidly eliminated from the body, as it plays a significant role in the dissolution rate of the fibers in a physiological medium. Mineral wools having high dissolution rates in a physiological medium (“biosoluble” mineral wools) have therefore been formulated and described in the prior art.

The main difficulty consists however in increasing the dissolution rate of the fibers in a physiological medium while retaining the good working properties of the end product, especially mechanical strength and the stability of this mechanical strength during aging in a humid environment. This latter point is particularly crucial and tricky, since the two criteria of wet strength and biosolubility are in most respects contradictory, as they both relate to the ability to be dissolved in a predominantly aqueous medium.

Wet-strength requirements are becoming increasingly strict in numerous applications, in particular in the field of glass wools used to produce construction components, especially “sandwich” panels, in which the mineral wool makes up an insulating core between two metal (for example steel or aluminum) facings. These construction components are mainly used for roofs and roof cladding, walls and exterior wall cladding, and walls, partition walls and ceilings located inside the building envelope. Considering the multiple mechanical stresses to which they may be subjected, very good compressive, tear and shear strength properties are demanded. It is important, moreover, that the mechanical strength, and especially the tear strength, of these products subjected to ambient humidity do not decline too significantly over time. These various requirements are in particular specified in the draft of standard prEN 14509 “Self-supporting double-skin metal-faced insulating sandwich panels—Factory made products—Specification”.

Patent Application WO 97/21636 describes a type of mineral fiber for which the resistance to aging in a humid environment is improved due to deposition of coating of ammonium or alkali metal phosphates or hydrogenphosphates on the surface of the fibers. This solution is not however free from disadvantages. It appears in fact that such phosphorus-based compounds lead to a significant decrease in the mechanical strength, especially compressive strength and tear strength, of fibrous products before aging relative to that of uncoated products. It would seem that the acidity developed by these compounds, probably originally from the improvement of the aging properties in a humid environment, is on the other hand prejudicial to the adhesion between the fibers and the resin-based sizing composition (“binder”) during the polymerization step of the latter.

One object of the present invention is therefore to obviate these disadvantages and to improve the aging resistance in a humid environment of the mineral wools that are soluble in a physiological medium, while retaining their good mechanical properties before aging (especially in terms of compressive strength and tear strength).

One subject of the invention is a mineral wool capable of being dissolved in a physiological medium comprising fibers whose chemical composition comprises the following constituents in the ranges defined below, expressed as percentages by weight:

| | |
|---|---|
| SiO₂ | 35 to 75 |
| Al₂O₃ | 0 to 12 |
| CaO | 0 to 30 |
| MgO | 0 to 20 |
| Na₂O | 0 to 20 |
| K₂O | 0 to 10 |
| B₂O₃ | 0 to 10 |
| Fe₂O₃ | 0 to 5 |
| P₂O₅ | 0 to 3, |

said mineral wool comprising moreover at least one phosphorus compound that is a molecule in which the phosphorus atom(s) is/are linked, directly or via an oxygen atom, to at least one carbon atom.

Preferably, each phosphorus compound is a molecule in which the phosphorus atom(s) is/are linked, directly or via an oxygen atom, to at least one carbon atom.

The phosphorus compound is deposited over at least one portion of the surface of the mineral fibers and therefore does not form a part of the chemical composition of the glass fiber itself.

The or each phosphorus compound may be a single molecule, that is to say, may contain only one phosphorus atom.

The phosphorus compound according to the invention may then be characterized in that the single phosphorus atom is directly linked only to oxygen or hydrogen atoms, that is to say, is linked to at least one carbon atom only by means of an oxygen atom. It may be, as an example, a mono-, di- or tri-phosphoric ester, or unsubstituted phosphonic or phosphinic esters, the carbon-based groups of these esters being alkyl, aryl, alkenyl, alkynyl, acyl or hydroxyalkyl compounds, which may possibly be of oligomeric or polymeric nature and/or contain one or more heteroatoms chosen from N, O or S.

It may alternatively be characterized in that the single phosphorus atom is directly linked to at least one carbon atom It may be at least partially substituted phosphonic or phosphinic esters or acids (that is to say in which at least one of the hydrogen atoms linked to the phosphorus atom is substituted by a carbon-based substituent). The various carbon-based groups of these compounds are alkyl, aryl, alkenyl, alkynyl, acyl or hydroxyalkyl compounds, which may possibly be of oligomeric or polymeric nature and/or contain one or more heteroatoms chosen from N, O or S.

The or each phosphorus compound according to the invention is, however, preferably a molecule made up of several identical or different unitary compounds such as described previously, linked together by covalent bonds. The phosphorus compound is then preferably an oligomer or polymer molecule, that is to say, that its structure may be represented as repeating constituent units. The number of these constituent units is advantageously between 2 and 100, especially 2 and 50, or even between 2 and 10. In the case of a molecule containing several phosphorus atoms, the key condition, in accordance with which the phosphorus atoms are linked to a carbon atom, must be seen as signifying that the large majority of the phosphorus atoms respect this condition, it being understood that, in a large molecule, the fact that a small fraction of the phosphorus atoms do not meet this condition is unable to substantially change the manner in which the technical problem is solved.

It may thus be a compound in which the majority (or even all) of the phosphorus atoms are linked together by an oxygen atom, for example phosphoric or phosphonic polyester-type compounds.

It is, however, more advantageous that the majority (or even all) of the phosphorus atoms be linked together via a carbon-based entity. The phosphorus compound then contains preferably a majority of phosphorus atoms linked together by a group comprising at least one carbon atom, this latter which may be linked directly or by means of an oxygen atom to at least one of the phosphorus atoms. Such a preferred compound may be represented according to the general formula (1) below:

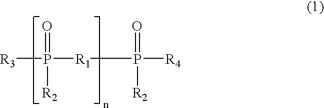

where:

n is between 1 and 100, preferably between 1 and 50, especially between 2 and 10;

the substituents R₁ to R₄ are identical or different, predominantly carbon-based entities, preferably of possibly branched alkyl, aryl, alkenyl, alkynyl, acyl or hydroxyalkyl type, which may possibly be of oligomeric or polymeric nature and/or contain one or more heteroatoms chosen from N, O, S or P. It is preferable that at least one of these substituents, especially the substituent R₁, contains an oxygen atom linked to the phosphorus atom of the main chain.

If two of the substituents contain an oxygen atom linked to the phosphorus atom of the main chain, the phosphorus compound is advantageously a phosphonic polyester-type oligomer or polymer of general formula (2) below:

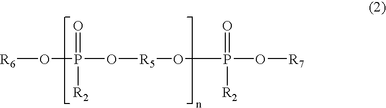

When all the substituents contain an oxygen atom linked to the phosphorus atom of the main chain, another family of preferred phosphorus compounds is made up of phosphoric polyacid- or polyester-type oligomers or polymers of general formula (3) below:

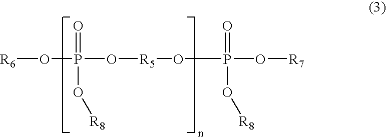

For these last two types of compounds:

the chain length n is between 1 and 100, preferably between 1 and 50, especially between 2 and 10;

the substituents R₂ and R₅ to R₈ are identical or different, predominantly carbon-based entities, preferably of possibly branched alkyl, aryl, alkenyl, alkynyl, acyl or hydroxyalkyl type, which may possibly be of oligomeric or polymeric nature and/or contain one or more heteroatoms chosen from N, O, S or P. The number of carbon atoms in each substituent is advantageously between 1 and 15, especially between 2 and 10. A large number of carbon atoms has in fact the disadvantage of generating a large quantity of carbon-based residues at the time of a temperature rise, whereas too small a number of carbon atoms may result in too easy a hydrolysis. The substituents R₆ to R₈ may also be hydrogen atoms or a neutralizing base for the phosphoric acid.

When the chain length n is equal to 1, it is possible that the R₅ and R₆ groups be linked together covalently thus forming a cyclic molecule. When n is greater than 1, some R₅, R₆ or R₇ groups may be linked together covalently. A preferred phosphorus compound is thus the product sold under the trademark AMGARD® CT or CU by Rhodia. It is a mixture of two cyclic phosphonic esters of CAS numbers 41203-81-0 and 42595-45-9 respectively. The first one is a phosphonic ester according to the formula (2) with n=1, all the R₂ and R₇ groups being methyl groups, the R₅ and R₆ groups being linked together to form a single alkyl group having 6 carbon atoms. The second one is an ester of the same type, with however n=2, all the R₂ groups being methyl groups, the two R₅ groups being respectively linked to the R₆ and R₇ groups to form two C₆ alkyl groups.

The oligomeric or polymeric phosphorus compounds, presented thus far as linear or cyclic chains, may also be crosslinked networks, the various predominantly carbon-based substituents being able to be themselves linked to at least one other phosphorus atom, for example when these substituents are polyols or polyacids.

The latter compounds may in particular be obtained by esterification or transesterification reactions between acids or esters, that are phosphonic and phosphoric respectively, and polyols (in particular diols), polyacids (in particular diacids) or else epoxy compounds. Within this scope, molasses (a by-product of sugar refining) are a particularly attractive source of polyols or diols due to their low cost. It appeared that the phosphorus compounds according to the invention were able to be obtained by reaction between molasses and the phosphoric or phosphonic acids or esters, this reaction which may even be carried out by simultaneously spraying the two products on the fibers. Phosphorus-based starches may also be employed.

The mineral wool according to the invention may advantageously comprise a mixture of several phosphorus compounds such as described previously.

The point that is common to these compounds which could be termed “organophosphorus compounds”, is the presence of carbon-based compounds within the phosphorus chain itself. In comparison with the phosphorus-based compounds described in the prior art, which do not have carbon-based compounds linked to them, it would seem, without wanting to be tied by any scientific theory, that the acid buffer function of the compounds according to the invention manifests itself more diffusely over time and degrades the adhesion between the fibers and the resin-based binder much less at the time of curing the latter resin. Thus the better mechanical properties before aging obtained within the scope of the present invention could be explained.

The phosphorus compound according to the invention is preferably present in an amount greater than or equal to 0.05%, especially 0.1%, and less than or equal to 5%, especially 3%. This quantity corresponds to the mass of phosphorus compounds relative to the total mass of fibers.

Considering the mass of phosphorus in these types of compounds, the mass content of phosphorus atoms relative to the mass of fibers is advantageously between 0.0005% to 1%, especially greater than or equal to 0.01% and even 0.1% and less than or equal to 0.5%.

The phosphorus compounds described have the drawback of being hydrophilic, it may be advantageous to add water-repellent agents to these compounds or with the sizing composition in order to limit the water uptake of the end product. Silicone-type (polysiloxane) water-repellent agents are particularly valued. The amount added is preferably between 0.01% and 1%, especially between 0.05 and 0.2% by weight.

A particularly preferred fiber composition within the scope of the present invention comprises the following constituents in the ranges defined below, expressed as percentages by weight:

| | |
|---|---|
| SiO₂ | 45 to 75 |
| Al₂O₃ | 0 to 10 |
| CaO | 0 to 15 |
| MgO | 0 to 15 |
| Na₂O | 12 to 20 |
| K₂O | 0 to 10 |
| B₂O₃ | 0 to 10 |
| Fe₂O₃ | 0 to 5 |
| P₂O₅ | 0 to 3. |

Silica (SiO₂) is a glass network former component. Too large an amount makes the viscosity of the glass too high for it to be properly melted, homogenized and refined, whereas too low an amount makes the glass thermally unstable (it devitrifies too easily on cooling) and chemically unstable (too prone to attack by moisture). The silica content is advantageously greater than or equal to 50%, or 55% and even 60% and less than or equal to 70%.

Alumina (Al₂O₃) is also a network former component capable of significantly increasing the viscosity of the glass. Present in too large an amount, it also has a negative impact on the solubility in the pulmonary alveolar fluid. When its content is low, the wet strength is greatly reduced. For these various reasons, the alumina content is advantageously greater than or equal to 1% and less than or equal to 5%, especially 3%.

The alkaline-earth metal oxides, mainly lime (CaO) and magnesia (MgO), make it possible to reduce the high-temperature viscosity of the glass and thus facilitate the processing steps for producing a glass free from gaseous or solid inclusions. By substitution relative to the alkali metal oxides, they significantly improve wet strength of the glass, but on the other hand they favor devitrification, making the fiberizing steps difficult. The calcium oxide content is therefore advantageously greater than or equal to 5%, especially 7%, and less than or equal to 10%. As for the magnesia, its content is preferably less than or equal to 10%, even 5%, and greater than or equal to 1%, or even 2%. Other alkaline-earth metal oxides such as barium oxide (BaO) or strontium oxide (SrO) may also be present in the mineral wools according to the invention. Considering their high cost, they are however advantageously not present (apart from traces stemming from inevitable impurities of the raw materials).

The alkali metal oxides, mainly sodium oxide (Na₂O) and potassium oxide (K₂O), are particularly useful for reducing the high-temperature viscosity of the glass and increasing the devitrification resistance. They prove to be detrimental however to the aging resistance in a humid environment. The sodium oxide content is, as a consequence, preferably less than or equal to 18% and greater than or equal to 14%. The potassium oxide content is advantageously less than or equal to 5%, or 2% and even 1%, mainly for reasons linked to the availability of the raw materials.

Boron oxide (B₂O₃) is important for reducing the viscosity of the glass and improving the biosolubility of the fibers. Its presence tends, moreover, to improve the thermal insulating properties of the mineral wool, especially by lowering its thermal conductivity coefficient in its radiative component. Moreover, considering its high cost and its ability to volatilize at high temperatures, generating harmful emissions and requiring the production sites to be equipped with fume treatment plants, the boron oxide content is preferably less than or equal to 8%, especially 6%, and even 5%. A zero content is preferred in certain embodiments.

Iron oxide is limited to a content of less than 5% on account of its role in coloring the glass, but also in the ability of the glass to devitrify. A high iron content makes it possible to impart a very high temperature resistance to mineral wools of the “rock wool” type, but it makes fiberizing by the internal centrifugation technique difficult or even impossible in certain cases. The iron oxide content is preferably less than or equal to 3%, and even 1%.

Phosphorus oxide (P₂O₅) may advantageously be used, especially on account of its beneficial effect on the biosolubility.

The fibers according to the invention may also contain other oxides, in amounts by mass that generally do not exceed 3%, or 2% and even 1%. Among these oxides are the impurities commonly introduced by the natural or artificial (for example recycled glass, called cullet) batch materials used in this type of industry (among the most common are TiO₂, MnO, BaO, etc.). Impurities such as ZrO₂ are also commonly introduced by the partial dissolution in the glass of chemical elements deriving from the refractory materials used in the construction of furnaces. Certain traces again derive from compounds employed in glass refining: in particular, the sulphur oxide SO₃ that is very commonly employed is cited. The alkaline-earth metal oxides such as BaO, SrO and/or the alkali metal oxides such as Li₂O may be voluntarily included in the fibers according to the invention. Considering their cost, it is however preferable that the fibers according to the invention do not contain them. These various oxides, on account of their low content, do not in any case play any particular functional role which may change the manner in which the fibers according to the invention respond to the problem posed.

Another subject of the invention is a method of obtaining the mineral wools according to the invention, comprising a fiber-forming step, then a step of introducing, by spraying or impregnation of a solution, at least one phosphorus compound onto the surface of said fibers.

Yet another subject of the invention are the thermal and/or acoustic insulation products comprising at least one mineral wool according to the invention, in particular “sandwich” type construction components, in which the mineral wool makes up an insulating core between two metal (for example steel or aluminum) facings, these possibly self-supporting construction components being used in the construction of internal and external walls, roofs or ceilings.

The density of the insulation products according to the invention is preferably between 40 and 150 kg/m³ (this density does not take into account the mineral wool).

A final subject of the invention is the use of at least a molecule in which the phosphorus atom(s) is/are linked to at least one carbon atom, directly or by means of an oxygen atom, in order to improve the mechanical properties after aging in a humid environment of the mineral wools comprising fibers whose chemical composition comprises the following constituents in the ranges defined below, expressed as percentages by weight:

| | |
|---|---|
| SiO₂ | 35 to 75 |
| Al₂O₃ | 0 to 12 |
| CaO | 0 to 30 |
| MgO | 0 to 20 |
| Na₂O | 0 to 20 |
| K₂O | 0 to 10 |
| B₂O₃ | 0 to 10 |
| Fe₂O₃ | 0 to 5 |
| P₂O₅ | 0 to 3. |

The advantages offered by the glass fibers according to the invention will be better appreciated through the following examples, illustrating the present invention without however limiting it.

A mass of molten glass, of which the chemical composition (expressed in percentages by weight) is presented in table 1, was obtained by a method of melting batch materials using, as the main energy source, electrodes immersed in the glass bath.

TABLE 1

| Oxide | wt % |
|---|---|
| SiO₂ | 65 |
| Al₂O₃ | 2 |
| Na₂O | 16 |
| K₂O | 0.8 |
| CaO | 8 |
| MgO | 2.8 |
| B₂O₃ | 4.5 |
| Fe₂O₃ | 0.2 |
| Impurities | 0.7 |

This mass of molten glass was then converted into fibers by an internal centrifugation method, using a spinner comprising a basket forming a chamber for receiving the molten glass and a peripheral band pierced by a multitude of holes. Since the spinner was rotated about a vertical axis, the molten glass was ejected under the effect of a centrifugal force and the material escaping from the holes was attenuated into filaments with the assistance of an attenuating gas stream.

A size spray ring was placed beneath the spinners so as to spread the sizing composition uniformly over the glass wool that had just been formed. The sizing composition was mainly based on phenol-formaldehyde resin and urea diluted in water before being sprayed onto the fibers. Other types of sizing composition, in particular those that are formaldehyde-free, may, of course, also be used, alone or in mixtures. They may be for example:

compositions based on an epoxy resin of the glycidyl ether type and a non-volatile amine hardener (described in Application EP-A-0 369 848), which may also comprise an accelerator chosen from imidazoles, imidazolines and mixtures thereof;

compositions comprising a carboxylic polyacid and a polyol, preferably combined with a catalyst of the alkali metal salt of a phosphorus-containing organic acid type (described in Application EP-A-0 990 727);

compositions comprising one or more compounds incorporating a carboxylic functional group and/or a β-hydroxyalkylamide functional group (described in Application WO-A-93/36368);

compositions incorporating either a carboxylic acid and an alkanolamine, or a resin previously synthesized from a carboxylic acid and from an alkanolamine, and a polymer containing a carboxylic acid group (described in Application EP-A-1 164 163);

sizing compositions prepared in two steps consisting in mixing an anhydride and an amine under reactive conditions until the anhydride is substantially dissolved in the amine and/or has reacted with it, then in adding water and terminating the reaction (described in Application EP-A-1 170 265);

compositions containing a resin that comprises the polymer-free reaction product of an amine with a first anhydride and a second anhydride that is different from the first (described in Application EP-A-1 086 932);

compositions containing at least one polycarboxylic acid and at least one polyamine;

compositions comprising copolymers of carboxylic acid and of monomers containing alcohol functional groups such as described in Application US 2005/038193; and

compositions comprising polyols and polyacids or polyanhydrides such as maleic acid, described for example in Patent WO 2005/87837 or in U.S. Pat. No. 6,706,808.

These application or patents EP-A-0 369 848, EP-A-0 990 727, WO-A-93/36368, EP-A-1 164 163, EP-A-1 170 265, EP-A-1 086 932, US 2005/038193, WO 2005/87837, U.S. Pat. No. 6,706, 808 are incorporated as reference into the present application, along with applications WO 04/007395, WO 2005/044750, WO 2005/121191, WO 04/094714, WO 04/011519, US 2003/224119, US 2003/224120.

Aminoplast type resins (melamine-formaldehyde or urea-formaldehyde) may also be used within the scope of the invention.

The phosphorus compound was added to the sizing composition, but it may also be sprayed independently, using a second spray ring. The various phosphorus compounds used were the following:

comparative example A did not comprise a phosphorus compound;

ammonium dihydrogenphosphate, in an amount of 0.5% for comparative example B1 and 1% for comparative example B2. The use of this phosphorus compound to improve the aging resistance of the mineral fibers was especially described in the aforementioned Application WO 97/21636;

flame retardant with the trade name “EXOLIT OP 550” produced by Clariant GmbH. Based on a phosphoric polyester type oligomer, it is especially used as an agent for protecting polyurethanes against fire. The examples C1 and C2 according to the invention respectively contained 1 and 3% of it relative to the total mass of fibers;

flame retardant with the trade name “FYROL PNX” sold by Akzo Nobel, containing 19% of P₂O₅. It is a phosphoric polyester type oligomer of formula (3) in which n varies between 2 and 20, R₆, R₇ and R₈ are ethyl groups and R₅ is an ethylene group (CAS number 184538-58-7) Example D according to the invention contained 1% of it; and

triethyl phosphonoacetate (TEPA, CAS no. 867-13-0), normally used as a reaction intermediate. Example E according to the invention contained 1% of it.

Among other examples of phosphorus compounds according to the invention are the products BUDIT 341 or 3118F sold by Buddenheim. The mixture of cyclic phosphonic esters sold under the trademark AMGARD® CT or CU by Rhodia is also particularly interesting. This product, used as a fire retardant for polyester-based textiles, has in fact a higher stability than the product EXOLIT OP 550 at the temperature of the oven, and thus makes it possible to obtain better mechanical properties before aging. Its P₂O₅ content is about 20%.

The mineral wool thus sized was collected on a belt conveyor equipped with internal suction boxes which made it possible to keep the mineral wool in the form of a felt or a sheet on the surface of the conveyor. The conveyor then passed through an oven where the polycondensation of the resin of the size took place. The insulation product manufactured was a panel with a density of around 80 kg/m³.

The following mechanical tests were undertaken after manufacturing the product, but before any aging test:

Compressive Strength Test:

The compressive strength test, carried out according to the standard NF EN 826, consisted in applying a compression stress using a loading machine to a sample with an area measuring 200×200mm². The compressive strength was given by the pressure (in kPa) corresponding to a deformation of 10%.

Tear Strength Test:

The tear strength test was carried out according to the principles of the standard NF EN 1607. It consisted in subjecting a sample with an area measuring 200×200mm² stuck between two sheets of wood to a tensile stress along an axis perpendicular to the surface of the sheets until the sample ruptured.

Table 2 contains the results of these various tests, the initial (that is to say before aging in a humid environment) compressive and tear strengths being expressed in percentages relative to the reference of the comparative example A, taken arbitrarily as 100%.

TABLE 2

| | | Compressive | Tear |
|---|---|---|---|
| | | strength | strength |
| Comparative | A | 100% | 100% |
| examples | B1 | 81% | |
| | B2 | 63% | 73% |
| Examples | C1 | 87% | 99% |
| according | C2 | 100% | |
| to the | D | 91% | |
| invention | E | 94% | 110% |

These results clearly show that the addition of inorganic phosphates known from the prior art strongly degrades the compressive strength and tear strength properties of mineral wools, even more so when the content level of such phosphates is high.

The addition of phosphorus compounds according to the invention makes it possible, on the other hand, to minimize the initial losses of mechanical strength relative to the uncoated products, or even surprisingly to improve their initial tear strength (example E).

The sandwich panels comprising a mineral wool whose composition corresponds to the previously described examples A (comparative), B1 (comparative), C1, C2 and D were subjected to the tear strength test after aging in a humid environment described in the draft of standard prEN 14509 “Self-supporting double-skin metal-faced insulating sandwich panels—Factory made products—Specification”. The sandwich panels were placed in an environmental chamber at 65° C. and 100% relative humidity for 28 days, the loss of tear strength after aging having not to exceed 60%. Table 3 describes the results, expressed in terms of loss (in percent) of tear strength.

TABLE 3

| Reference | Loss after aging (%) |
|---|---|
| A | 80-85% |
| B1 | 65% |
| C1 | 44% |
| C2 | 20% |
| D | <40% |

Two mineral wools, one according to example C1, the other according to the same example but into which a silicone had been injected, in this case an aqueous solution of polydimethylsiloxane sold under the trademark Dow Corning® 1581 at a level of 0.1 wt %, were subjected to tests of partial immersion in water according to the standard NF EN 1609.

In the absence of silicone, the water uptake was 1.47 kg/m², whereas it dropped to 0.4 kg/m² in the presence of silicone. The compressive and tear strength results (before and after aging in a humid environment) are not, on the other hand, affected by the presence of silicones.

The use of mineral wools according to the invention makes it possible therefore to obtain excellent results in terms of aging. The improvement over the mineral wools free from phosphorus compounds was spectacular, whereas a clear improvement over the mineral wools coated with inorganic phosphorus compounds known from the prior art was also observed.

1. A mineral wool capable of being dissolved in a physiological medium comprising fibers whose chemical composition comprises the following constituents in the ranges defined below, expressed as percentages by weight:

| | |
|---|---|
| SiO₂ | 35 to 75 |
| Al₂O₃ | 0 to 12 |
| CaO | 0 to 30 |
| MgO | 0 to 20 |
| Na₂O | 0 to 20 |
| K₂O | 0 to 10 |
| B₂O₃ | 0 to 10 |
| Fe₂O₃ | 0 to 5 |
| P₂O₅ | 0 to 3, |

said mineral wool comprising moreover at least one phosphorus compound, characterized in that one phosphorus compound is a molecule in which the phosphorus atom(s) is/are linked, directly or via an oxygen atom, to at least one carbon atom.

2. The mineral wool as claimed in claim 1, comprising at least one phosphorus compound chosen from:
a) a molecule containing a single phosphorus atom linked to at least one carbon atom, strictly by means of an oxygen atom;
b) a molecule containing a single phosphorus atom linked directly to at least one carbon atom.

3. The mineral wool as claimed in claim 2, comprising at least one phosphorus compound (a) chosen from: a mono-, di- or tri-phosphoric ester, or an unsubstituted phosphonic or phosphinic ester, the carbon-based groups of these esters being alkyl, aryl, alkenyl, alkynyl, acyl or hydroxyalkyl compounds, which may possibly be of oligomeric or polymeric nature and/or contain one or more heteroatoms chosen from N, O or S.

4. The mineral wool as claimed in claim 2, comprising at least one phosphorus compound (b) chosen from an at least partially substituted phosphonic or phosphinic ester or acid, the various carbon-based groups of these compounds being alkyl, aryl, alkenyl, alkynyl, acyl or hydroxyalkyl compounds, which may possibly be of oligomeric or polymeric nature and/or contain one or more heteroatoms chosen from N, O or S.

5. The mineral wool, comprising at least one phosphorus compound that is a molecule made up of several compounds of type (a) or (b) as claimed in claim 2, that are identical or different, linked together by covalent bonds.

6. The mineral wool as claimed in claim 5, comprising at least one phosphorus compound that is an oligomer or polymer molecule, of which the number of constituent units is between 2 and 100.

7. The mineral wool as claimed in claim 5, comprising at least one phosphorus compound that contains predominantly phosphorus atoms linked together via a carbon-based entity.

8. The mineral wool as claimed in claim 7, comprising at least one phosphorus compound that may be represented according to the general formula (1) below: 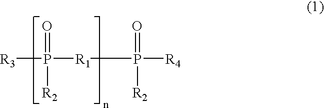
in which:
n is between 1 and 100;
the substituents R₁ to R₄ are identical or different, predominantly carbon-based entities, which may be of oligomeric or polymeric nature and/or contain one or more heteroatoms chosen from N, O, S or P.

9. The mineral wool as claimed in claim 1, comprising at least one phosphorus compound that is a phosphonic polyester-type oligomer or polymer of general formula (2) below: 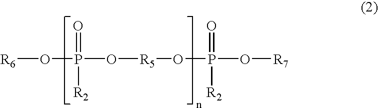
in which:
the chain length n is between 1 and 100;
the substituents R₂ and R₅ to R₇ are identical or different, carbon-based entities, which may possibly be of oligomeric or polymeric nature and/or contain one or more heteroatoms chosen from N, O, S or P.

10. The mineral wool as claimed in claim 8, comprising at least one phosphorus compound that is a phosphoric polyacid or polyester-type oligomer or polymer of general formula (3) below: 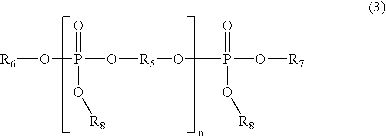
in which:
the chain length n is between 1 and 100;
the substituents R₅ to R₈ are identical or different, predominantly carbon-based entities, which may possibly be of oligomeric or polymeric nature and/or contain one or more heteroatoms chosen from N, O, S or P.

11. The mineral wool as claimed in claim 4, comprising at least one phosphorus compound that is obtained by an esterification or transesterification reaction between acids or esters, that are phosphonic and phosphoric respectively, and polyols, polyacids or epoxy compounds.

12. The mineral wool as claimed in claim 11, comprising at least one phosphorus compound that is obtained by reaction between molasses and the phosphoric or phosphonic acids or esters.

13. The mineral wool as claimed in claim 1, in which the amount of phosphorus compound, expressed by mass of phosphorus atoms, varies from 0.0005%, especially more than 0.01%, to 1%, especially less than 0.5% of the total mass of fibers.

14. A method of obtaining the mineral wools as claimed in claim 10, comprising a fiber-forming step, then a step of introducing, by spraying or impregnation of a solution, at least one phosphorus compound onto the surface of said fibers.

15. A thermal and/or acoustic insulation product comprising at least one mineral wool as claimed in claim 1.

16. A “sandwich” type construction component comprising mineral wool as claimed in claim 1 s an insulating core between two metal facings.

17. The method of using at least one molecule in which the phosphorus atom(s) is/are linked to at least one carbon atom, directly or by means of an oxygen atom, in order to improve the mechanical properties after aging in a humid environment of the mineral wools comprising fibers whose chemical composition comprises the following constituents in the ranges defined below, expressed as percentages by weight:

| | |
|---|---|
| SiO₂ | 35 to 75 |
| Al₂O₃ | 0 to 12 |
| CaO | 0 to 30 |
| MgO | 0 to 20 |
| Na₂O | 0 to 20 |
| K₂O | 0 to 10 |
| B₂O₃ | 0 to 10 |
| Fe₂O₃ | 0 to 5 |
| P₂O₅ | 0 to 3. |
